(19) United States
(12) Patent Application Publication
(10) Pub. No.: US 2024/0101484 A1
(43) Pub. Date: Mar. 28, 2024

(54) CERAMIC MATRIX COMPOSITE AND METHOD FOR PRODUCING CERAMIC MATRIX COMPOSITE

(71) Applicant: Mitsubishi Electric Corporation, Tokyo (JP)

(72) Inventors: Masami KUME, Tokyo (JP); Yohei ITO, Tokyo (JP)

(73) Assignee: Mitsubishi Electric Corporation, Tokyo (JP)

(21) Appl. No.: 18/267,105

(22) PCT Filed: Jan. 26, 2021
(86) PCT No.: PCT/JP2021/002601

§ 371 Date: Dec. 15, 2023

(51) Int. Cl. C04B 35/563; C04B 35/524; C04B 35/78; C04B 41/00; C04B 41/45; C04B 41/50

(52) U.S. Cl. CPC C04B 35/563; C04B 35/524; C04B 35/78; C04B 41/0072; C04B 41/457; C04B 41/50; C04B 2235/3821; C04B 2235/48; C04B 2235/5216; C04B 2235/616; C04B 2235/66

(57) ABSTRACT

A ceramic matrix composite includes, as a matrix, boron carbide, silicon carbide, and metal silicon or a silicon alloy. The boron carbide is contained as a main component of the matrix.

### TECHNICAL FIELD

The present disclosure relates to a ceramic matrix composite and a method for producing the ceramic matrix composite, and more particularly to a matrix of a ceramic composite.

### BACKGROUND ART

To take measures against a steep rise in fuel prices or meet the demand for reducing CO₂ emissions, there are increasing demands for energy saving in air conditioners, cooling energy devices, automobiles or aircrafts equipped with combustion engines, and other vehicles. Air conditioners or cooling energy devices require high efficiency of compressors for energy saving. To achieve this, driving parts need to be light in weight and high in rigidity. To improve the efficiency of gas turbine engines or turbine generators, there is a need to elevate the operating temperature or reduce the weight of turbines.

Materials that satisfy these requirements have been studied, and iron-based, nickel-based, and cobalt-based alloys have been developed to improve high-temperature performance. However, weight reduction is still insufficient, and alternative lightweight materials have been investigated for weight reduction. Lightweight ceramic materials have attracted attention as heat-resistant materials because they are highly heat-resistant and have lower density than metal materials. However, ceramic materials are relatively brittle, and ceramic matrix composites (CMCs), ceramic materials combined with fibers or other materials, have been in the spotlight for application to structural parts. In general, CMCs are materials produced by combining a ceramic matrix with reinforcing fibers. As one of CMGs, SiC/SiC formed by combining SiC (silicon carbide) used as a matrix and SiC fibers used as reinforcing fibers has been developed (e.g., see Patent Literature 1) and put to practical use.

### CITATION LIST

### Patent Literature

Patent Literature 1: Japanese Patent No. 5825761

### SUMMARY OF INVENTION

### Technical Problem

Current SiC fiber products that have the highest performance have a tensile modulus of elasticity (Young's modulus) of 380 GPa and a density of 2.85 (g/cm³) to 3.1 (g/cm³). The SiC fiber products has a specific elastic modulus (Young's modulus/density), which is an elastic modulus per unit density, of about 122.6 (GPa/(g/cm³)) to 133.3 (GPa/(g/cm³)). There is a need of further improvement in the specific elastic modulus of materials used for compressors, gas turbine engines, or turbine generators described above.

The present disclosure is made to solve the above problems and directed to a ceramic matrix composite having a high specific elastic modulus and a method for producing the ceramic matrix composite.

### Solution to Problem

A ceramic matrix composite according to one embodiment of the present disclosure includes, as a matrix, boron carbide, silicon carbide, and metal silicon or a silicon alloy, wherein boron carbide is contained as a main component of the matrix.

A method for producing a ceramic matrix composite according to the present disclosure includes: mixing a boron carbide powder, a carbon precursor, and a matrix filler to form a raw material mixture; performing molding by charging the raw material mixture into a mold and heating and pressing the raw material mixture into a green compact; performing a heat treatment by heating the green compact in an inert atmosphere or in vacuum to carbonize the carbon precursor and thus to obtain a sintered compact; performing infiltration by heating the sintered compact in an inert atmosphere or in vacuum and melting metal silicon or a silicon alloy to impregnate the sintered compact with metal silicon or the silicon alloy; and performing reaction sintering by causing the metal silicon or the silicon alloy impregnated into the sintered compact to react with carbon in the sintered compact to form silicon carbide and thus to sinter the sintered compact.

### Advantageous Effects of Invention

According to an embodiment of the present disclosure, a ceramic matrix composite includes, as a matrix, boron carbide, silicon carbide, and metal silicon or a silicon alloy, wherein the boron carbide is contained as a main component of the matrix. A combination of material compositions of boron carbide (B₄C), silicon carbide (SiC), and metal silicon or a silicon alloy, which serves as silicon (Si), can reduce the density of the ceramic matrix composite and can increase the specific elastic modulus of the ceramic matrix composite to increase the specific elastic modulus.

According to an embodiment of the present disclosure, a method for producing a ceramic matrix composite can produce a ceramic matrix composite containing boron carbide (B₄C) as a main component of the matrix through the production process from the raw material mixing step to the infiltration step and the reaction sintering step. The method for producing a ceramic matrix composite can produce a ceramic matrix composite having a higher specific elastic modulus than ceramic matrix composites known in the related art.

### BRIEF DESCRIPTION OF DRAWINGS

FIG. 1 is a cross-sectional view of the structure of a matrix of a ceramic matrix composite according to Embodiment 1.

FIG. 2 is a cross-sectional view of the structure of the ceramic matrix composite according to Embodiment 1.

FIG. 3 is a flowchart of a method for producing the ceramic matrix composite according to Embodiment 2.

FIG. 4 is a flowchart of a molding process for incorporating a reinforcing fiber as the core of a rod into a ceramic matrix composite according to Embodiment 3.

### DESCRIPTION OF EMBODIMENTS

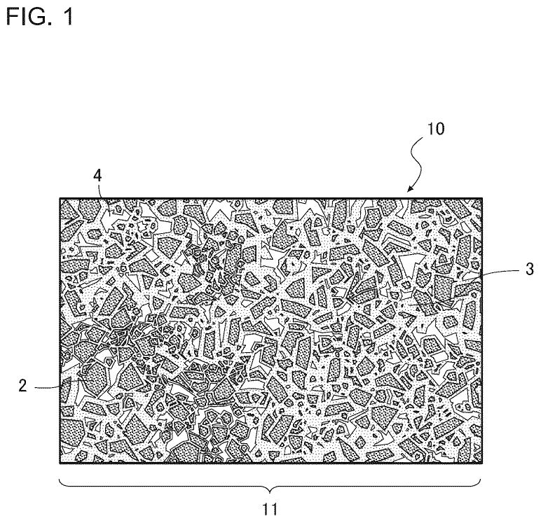

A ceramic matrix composite and a method for producing a ceramic matrix composite according to Embodiments of the present disclosure will be described below with reference to, for example, the drawings. In the following drawings including FIG. 1, the same reference characters denote the same or corresponding components. The same applies to the entire description of the following Embodiments. In addition, the forms of components in the entire description are merely illustrative and not limited to the forms in the description.

### Embodiment 1

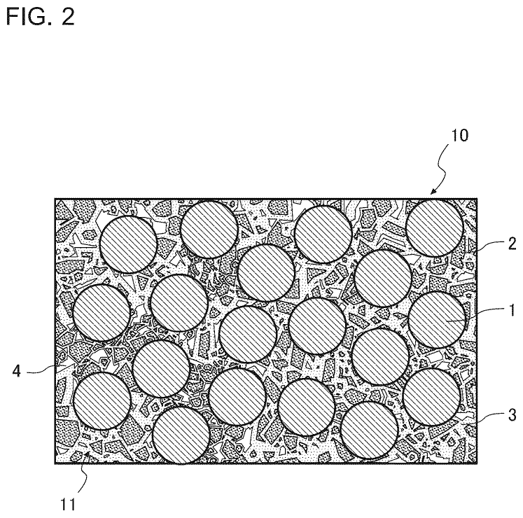

FIG. 1 is a cross-sectional view of the structure of a matrix 11 of a ceramic matrix composite 10 according to Embodiment 1. FIG. 2 is a cross-sectional view of the structure of the ceramic matrix composite 10 according to Embodiment 1. The structure of the ceramic matrix composite 10 will be described with reference to FIG. 1 and FIG. 2.

Referring to FIG. 1, the ceramic matrix composite 10 according to one embodiment of the present disclosure has the matrix 11 as a base material. The matrix 11 has a composition including boron carbide 2 (B₄C), silicon carbide 3 (SiC), and metal silicon or a silicon alloy, which serves as silicon 4 (Si). The main component of the matrix 11 is the boron carbide 2. Examples of commercial products of the boron carbide 2 include Boron Carbide Powder F500 available from 3M.

The volume ratio of the boron carbide 2 (B₄C), a main component, in the structure of the matrix 11 is 50% or more. The matrix 11 contains the silicon carbide 3 (SiC) and metal silicon or a silicon alloy, which serves as the silicon 4 (Si), as other components of the matrix 11. The presence of a large amount of the silicon 4 (Si) or the silicon carbide 3 (SiC) in the matrix 11 results in a low apparent specific elastic modulus. Therefore, the volume ratio of the boron carbide 2 (B₄C), which solely has the highest specific elastic modulus, in the matrix 11 is 50% or more, and the boron carbide 2 (B₄C) is a main component of the matrix 11.

The boron carbide 2 (B₄C), a main component of the matrix 11, has a Young's modulus of 450 GPa and a density of 2.52 (g/cm³) and therefore has a specific elastic modulus (450/2.52) of 178.6 (GPa/(g/cm³)). Since the boron carbide 2 (B₄C) has a higher elastic modulus, a lower density, and a higher elastic modulus than the silicon carbide 3 (SiC), the boron carbide 2 (B₄C) is a material expected to improve the specific elastic modulus of the ceramic matrix composite 10 containing the boron carbide 2 (B₄C) as a main component of the matrix 11.

The silicon 4 (Si) is metal silicon. Alternatively, the silicon 4 (Si) is a silicon alloy. The reason why silicon (Si) is contained is that it is difficult to eliminate the silicon 4 (Si) and fill with other components from the viewpoint of production process. It is possible to substitute the silicon 4 (Si) by voids, but the voids correspond to defects of the composite and degrade the properties of the composite. Instead of leaving the voids empty, filling the voids with the silicon 4 (Si) improves the properties of the composite and improves the specific elastic modulus.

Referring to FIG. 2, the ceramic matrix composite 10 according to one embodiment of the present disclosure may include the matrix 11 and a reinforcing fiber 1. The reinforcing fiber 1 is a continuous fiber or short fiber, or both a continuous fiber and a short fiber. The reinforcing fiber 1 is any one of carbon fibers, boron fibers, and inorganic fibers, or a combination of two or more of carbon fibers, boron fibers, and inorganic fibers. Examples of commercial products of the reinforcing fiber 1 include Dialead (registered trademark) K63712 available from Mitsubishi Chemical Corporation. A combination of the matrix 11 with the reinforcing fiber 1 having a higher specific elastic modulus than boron carbide (B₄C) or silicon carbide (SiC) can make the specific elastic modulus of the ceramic matrix composite 10 higher than that of the matrix 11 alone.

The reinforcing fiber 1 and the boron carbide 2 are fixed to each other with the silicon carbide 3, which is a matrix filler. The silicon carbide 3 is produced by infiltration of the sintered compact with silicon or a silicon alloy, which reacts with carbon or graphite present in the sintered compact before infiltration. The silicon carbide 3, a matrix filler, may be one produced by the reaction, or may be a silicon carbide powder added in advance. Examples of commercial products of the silicon carbide 3, a matrix filler, include GMF 1000H2 available from Pacific Rundum Co., Ltd. The matrix filler may contain not only a silicon carbide powder but also, for example, graphite.

Carbon inside the sintered compact is produced by carbonization of the carbon precursor used in the raw material mixture. The raw material mixture is used to form a green compact before firing. The carbon precursor is preferably a thermoplastic resin, for example, a powdery phenol resin. The carbon precursor may be a boron carbide powder with the surface coated with a liquid resin, instead of a powdery resin. Examples of commercial products of the powdery phenol resin, a carbon precursor, include PG-9400 available from Gunei Chemical Industry Co., Ltd. The carbon precursor is not limited to a thermoplastic resin.

The carbon precursor may include a resin and one or both of a graphite powder and a carbon fiber. In other words, the carbon precursor may include a resin and a graphite powder, a resin and a carbon fiber, or a resin, a graphite powder, and a carbon fiber. The resin is a binder essential to mold powder raw materials. Graphite or carbon is required for the reaction for producing silicon carbide (SiC). The resin alone cannot ensure a carbon content required for the reaction for producing silicon carbide (SiC). For this, the carbon precursor is formed by mixing a resin with a graphite powder or a carbon fiber, or formed by mixing a resin with a graphite powder and a carbon fiber.

Graphite may be a graphite powder or a milled fiber that is a milled carbon fiber. Examples of commercial products of milled fibers made of graphite include K6371M available from Mitsubishi Chemical Corporation.

To improve the uniformity of the green compact and the packing rate of boron carbide, the raw materials to be mixed preferably include raw materials having different average particle sizes in combination. The use of raw material powders having different particle sizes can easily improve the packing density of the raw materials at low pressure and enables uniform dispersion of the raw materials. These raw materials to be mixed are used such that the mixing ratio of the raw materials or the particle size distribution are balanced according to the reinforcing fiber 1 to be combined or the physical properties after sintering. To improve the packing rate of the boron carbide powder, which is a main component, the average particle size distribution of the powder raw materials to be used is preferably larger than the average particle size distribution of the silicon carbide powder, which is a matrix filler.

### Examples

The details of the matrix 11 according to one embodiment of the present disclosure will be described below by way of Examples, but the content of the present disclosure is not limited by these Examples. The raw materials used in Examples are the commercial products described above. First, a boron carbide powder, a resin used as a carbon precursor, and silicon carbide used as a matrix filler were mixed as raw materials at a weight ratio of 37:15:3, and the mixture was then charged into a mold and cured by heating to 150 degrees C. to form a green compact.

Boron carbide (B₄C) is defined as a main component of the matrix 11, and the volume ratio of the boron carbide 2 (B₄C), which is a main component, in the matrix 11 is assumed to be 50% or more. From the viewpoint of production process, the weight ratio is used when the raw materials are mixed. This is because it is easier and more accurate to control the weight ratio than the volume ratio. The resin is thermally decomposed by a heat treatment in a downstream process and then converted into silicon carbide (SiC) by SiC infiltration and SiC reaction sintering. The initial resin weight increases to 183%, but the volume decreases to about 68% because the resin is converted into silicon carbide (SiC). To obtain 50% or more of boron carbide (B₄C) by volume ratio, the weight ratio of boron carbide (B₄C) is set to 45% or more in terms of the weight ratio between boron carbide (B₄C), the resin, and silicon carbide (SiC). In this case, the volume ratio of boron carbide (B₄C) in the matrix 11 after SiC reaction sintering is 50% or more regardless of the ratio between silicon carbide (SiC) and the resin.

Next, the green compact was taken out of the mold and then heated to 800 degrees C. in an inert atmosphere so that the carbon precursor was thermally decomposed and carbonized to obtain a sintered compact.

The sintered compact and metal silicon are then put together in a graphite crucible and heated to 1600 degrees C. in a vacuum furnace to melt metal silicon, and the sintered compact is infiltrated with metal silicon. Carbon or graphite obtained by carbonizing the carbon precursor was then caused to react with silicon to produce silicon carbide (SiC), whereby sintering was carried out. The matrix 11 of the ceramic matrix composite 10 thus obtained had no cracks, and a dense sintered compact was obtained.

The obtained sintered compact had a density of 2.60 (g/cm³) and a Young's modulus of 410 GPa and thus had a specific elastic modulus of 157.7 (GPa/(g/cm³)), which was higher than the specific elastic modulus, 140.6 (GPa/(g/cm³)), of silicon carbide (SiC). It was confirmed that a combination of the matrix 11 having boron carbide, silicon carbide, and silicon with the reinforcing fiber 1 having a higher specific elastic modulus than the matrix 11 provided the ceramic matrix composite 10 with a higher specific elastic modulus.

The ceramic matrix composite 10 having boron carbide (B₄C) as a main component of the matrix 11 and further containing silicon carbide (SiC) and silicon (Si) has a lower density and a higher elastic modulus than CMC (SiC/SiC) composed of a SiC fiber and a SiC matrix. The ceramic matrix composite 10 composed of these materials has a low density and a high elastic modulus and thus has a high specific elastic modulus. In other words, the ceramic matrix composite 10 has high rigidity, low density, and high specific elastic modulus when the ceramic matrix is composed of a matrix material having boron carbide (B₄C) as a main component of the matrix 11 and containing silicon carbide (SiC) and silicon (Si).

A typical ceramic matrix composite (CMC) and an article formed by using the ceramic matrix composite will be described as Comparative Example. In a typical CMC, the matrix material is composed mainly of silicon carbide (SiC), and SiC fibers are used as reinforcing fibers. Silicon carbide (SiC) constituting the matrix has a Young's modulus up to about 450 GPa and a density up to about 3.2 (g/cm³), and thus has a specific elastic modulus (Young's modulus/density) of (450/3.2)=140.6 (GPa/(g/cm³)). When the SiC fiber is, for example, HI-NICALON (registered trademark) Type S fiber available from Nippon Carbon Co., Ltd., the Young's modulus is 380 GPa, and the density is 2.85 (g/cm³). The specific elastic modulus is (380/2.85)=133.3 (GPa/(g/cm³)). When the CMC includes the matrix and the reinforcing fiber at a volume ratio of 1:1 and has no void, the CMC has an elastic modulus of (450+380)/2=415 GPa and a density of (3.2+2.85)/2=3.025 (g/cm³). The specific elastic modulus is (415/3.025)=137.2 (GPa/(g/cm³)).

Heat-resistant alloys used in gas turbine engines known in the related art have a specific elastic modulus of about 25 (GPa/(g/cm³)). Improving engine combustion efficiency requires operation at higher temperatures, but there is a limit to operation at higher temperatures due to restrictions on heat-resistant temperature or high-temperature strength. Heat-resistant alloys are resistant up to about 1200 degrees C. The development goal of current CMGs composed of SiC/SiC is to achieve a heat-resistant temperature of 1400 degrees C. from the viewpoint of the high-temperature strength retention of the reinforcing fiber. The practical temperature of current CMGs is lower than 1400 degrees C. The heat resistance of current CMGs composed of SiC/SiC is up to about 1400 degrees C. due to the effect of high temperatures on decreases in fiber strength.

CMGs are used for shafts or other components of compressors used in high-speed turbochargers, air conditioners, or cooling energy devices, in addition to gas turbine engines, such as jet engines. To increase output, shafts or other components of compressors need to further increase its rotation speed. However, increasing the rotation of shafts causes torsion under the effect of the stiffness of shaft materials to generate vibration or warpage. There is thus a limit to increasing rotation speed, which is not realistic. To increase the stiffness of shafts, the shaft diameter needs to be large. However, thick shafts result in a large rotation loss associated with a large drive load and also increase the entire size to cause increases in weight, which is not preferred. Therefore, shafts or other components of compressors require high-elastic and lightweight shaft materials.

Ceramic materials are candidates for materials having higher heat resistance and lighter weight than heat-resistant alloys or steel materials. However, ceramic materials are much more brittle and more easily damaged than metal materials. It is thus difficult to use ceramic materials for common structural parts, and it is necessary to reduce brittleness. It is therefore considered that a matrix needs to be combined with a reinforcing fiber in ceramic materials known in the related art. SiC fibers are commercially available as continuous fibers (reinforcing fibers), and SiC/SiC has been developed as a CMC.

The ceramic matrix composite 10 according to one embodiment of the present disclosure contains, as a main component, boron carbide (B₄C) solely having a high specific elastic modulus. Therefore, a combination of material compositions of boron carbide (B₄C), silicon carbide (SiC), and silicon (Si) can reduce the density of the ceramic matrix composite 10 and can increase the specific elastic modulus of the ceramic matrix composite 10 to increase the specific elastic modulus. The ceramic matrix composite 10 according to one embodiment of the present disclosure has a heat-resistant temperature of 1500 degrees C. or higher, a high elastic modulus with an elastic modulus of 500 GPa or higher, a low density with a density of less than 2.8 (g/cm³), and a specific elastic modulus of 200 (GPa/(g/cm³)) or higher. Since the ceramic matrix composite 10 according to one embodiment of the present disclosure contains boron carbide (B₄C) as a main component of the matrix 11, the ceramic matrix composite 10 has a lower density and a higher elastic modulus, that is, a higher specific elastic modulus, than silicon carbide (SiC).

The ceramic matrix composite 10 is a sintered compact sintered as a result of the reaction production of silicon carbide (SiC). Since the ceramic matrix composite 10 contains boron carbide (B₄C) as a main component of the matrix 11, a combination of material compositions of boron carbide (B₄C), silicon carbide (SiC), and silicon (Si), can reduce the density of the ceramic matrix composite 10 and can increase the specific elastic modulus of the ceramic matrix composite 10 to increase the specific elastic modulus.

Common ceramic materials are produced by firing and sintering raw material bases. Common sintered compacts of boron carbide or silicon carbide also have been sintered by firing raw material powders under pressure. This case requires higher temperature and higher pressure in sintering and demands high capacity of facilities used for such sintering. Furthermore, shrinkage inevitably occurs during sintering to cause deformation, breakage, or other damages, which degrades manufacturability and leads to low yield. If no shrinkage occurs during sintering, the sintered compact has many voids, which degrades the properties of the composite.

The reaction sintering method according to one embodiment of the present disclosure eliminates the need of pressing during sintering and uses low temperatures. In particular, elimination of the need for pressing at high temperatures is a major advantage in general use of production facilities. In addition, external supply of raw materials, such as silicon (Si), used for the reaction can prevent shrinkage and void generation during sintering and significantly improves manufacturability and yield.

The process according to one embodiment of the present disclosure involves causing the resin of the carbon precursor or carbon of the milled fiber to react with infiltrated silicon (Si) to produce silicon carbide (SiC). This causes volume expansion so that silicon carbide (SiC) fills into gaps (voids), which eliminates the need of pressing. Since the entire reaction does not proceed at the same time or uniformly, an excessively expanded area may be generated when the voids are filled with silicon carbide (SiC) until no voids remain. In this case, cracking occurs. In the process according to one embodiment of the present disclosure, a few voids are intentionally left, and the voids are filled with silicon (Si). In the reaction of silicon carbide (SiC), silicon (Si) is liquid in a molten state, but silicon carbide (SiC) produced by the reaction is solid, and cracking does not occur when voids are present.

The ceramic matrix composite 10 contains a continuous fiber or a short fiber as the reinforcing fiber 1. In the ceramic matrix composite 10, the matrix 11 composed of a combination of boron carbide (B₄C), silicon carbide (SiC), and silicon (Si) is combined with the reinforcing fiber 1. Having the reinforcing fiber 1, the ceramic matrix composite has a lower density, a higher elastic modulus, and a higher specific elastic modulus than the matrix 11 alone. Since the matrix 11 composed of a combination of boron carbide (B₄C), silicon carbide (SiC), and silicon (Si) is combined with the reinforcing fiber 1 in the ceramic matrix composite 10, the ceramic matrix composite 10 has higher strength than the matrix 11 alone.

The reinforcing fiber 1 is any one of carbon fibers, boron fibers, and inorganic fibers, or a combination of two or more of carbon fibers, boron fibers, and inorganic fibers. The combination of the ceramic matrix composite 10 with the reinforcing fiber 1 can further overcome the brittleness that common ceramic matrix composites have and further can provide the ceramic matrix composite with low density and high elasticity.

### Embodiment 2

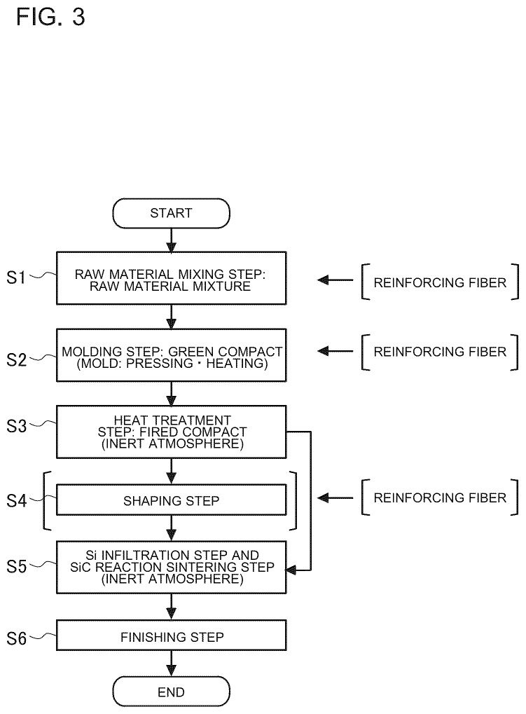

FIG. 3 is a flowchart of a method for producing the ceramic matrix composite 10 according to Embodiment 2. The same components as those in the ceramic matrix composite 10 according to Embodiment 1 are assigned with the same reference signs, and description thereof is omitted. The method for producing the ceramic matrix composite 10 will be described with reference to FIG. 3.

The method for producing the ceramic matrix composite 10 according to one embodiment of the present disclosure includes six steps. The six steps include a raw material mixing step (Step S1), a molding step (Step S2), a heat treatment step (Step S3), a shaping step (Step S4), a Si infiltration step and a SiC reaction sintering step (Step S5), and a finishing step (Step S6).

The raw material mixing step (Step S1), which is the first step, involves uniformly mixing raw materials, such as a boron carbide powder, a resin used as a carbon precursor, and a silicon carbide powder and graphite used as a matrix filler at a predetermined mixing ratio, to form a raw material mixture. The average particle size distribution of the powder raw materials in the raw material mixture preferably has two or more different modes.

The average particle size distributions of boron carbide (B₄C) and silicon carbide (SiC) used as powder raw materials are determined as examples as in Table 1. For example, when only boron carbide (B₄C) is used as a raw material powder (when no silicon carbide (SiC) powder is used), two or more boron carbide (B₄C) powders having different average particle sizes are used. When powders of boron carbide (B₄C) and silicon carbide (SiC) are used, boron carbide (B₄C) and silicon carbide (SiC) powders having different average particle size distributions are used. The average particle size of boron carbide (B₄C)) is larger than that of silicon carbide (SiC). There are at least two modes, and there may be four modes in total, two small modes and two large modes.

TABLE 1

| | | | Relationship |
|---|---|---|---|
| | Boron carbide: | Silicon carbide: | of particle size |
| | B₄C | SiC | distribution |
| Case 1 | ◯: 2 or more modes | X: 0 modes | 2 or more modes |
| Case 2 | ◯: 1 mode, or | ◯: 1 mode, or | B₄C > SiC |
| | 2 or more modes | 2 or more modes | |

The molding step (Step S2), which is the second step, involves charging, into a mold, the raw material mixture produced in the raw material mixing step (Step S1), and heating and pressing the raw material mixture into a green compact. The molding step (Step S2) may have a step of charging the reinforcing fiber 1.

The heat treatment step (Step S3), which is the third step, involves taking, out of the mold, the green compact formed in the molding step (Step S2), and then heating the green compact in a heat treatment in an inert atmosphere or in vacuum to carbonize the carbon precursor of the green compact and thus to obtain a sintered compact.

The shaping step (Step S4), which is the fourth step, involves processing the sintered compact, which is produced in the heat treatment step (Step S3), into a part shape to form a substrate. In the shaping step (Step S4), the carbonized sintered compact is machined as necessary and processed into a part shape to form a substrate. The shaping step (Step S4) is not an essential step, and the shaping step (Step S4) is not necessarily performed.

The Si infiltration step and the SiC reaction sintering step (Step S5), which is the fifth step, involves infiltration of the substrate with metal silicon or a silicon alloy so that metal silicon or the silicon alloy reacts with carbon and graphite in the substrate to produce silicon carbide and thus to sinter the substrate. In the Si infiltration step, the substrate shaped in the shaping step (Step S4) is heated together with metal silicon or the silicon alloy in vacuum or in an inert atmosphere. In the Si infiltration step, the substrate is heated in an inert atmosphere or in vacuum, metal silicon or the silicon alloy is melted, and the substrate is impregnated with metal silicon or the silicon alloy.

In the SiC reaction sintering step, metal silicon or the silicon alloy impregnated into the substrate is caused to react with carbon in the substrate to produce silicon carbide and thus to sinter the substrate.

If the shaping step (Step S4) is omitted, the Si infiltration step and the SiC reaction sintering step (Step S5) involve infiltration of the sintered compact with metal silicon or the silicon alloy so that metal silicon or the silicon alloy reacts with carbon and graphite in the sintered compact to produce silicon carbide and thus to sinter the sintered compact. In the Si infiltration step, the sintered compact obtained in the heat treatment step (Step S3) is heated together with metal silicon or the silicon alloy in vacuum or in an inert atmosphere. In the Si infiltration step, the sintered compact is heated in an inert atmosphere or in vacuum, and metal silicon or the silicon alloy is melted, so that the sintered compact is impregnated with metal silicon or the silicon alloy.

If the shaping step (Step S4) is omitted, the SiC reaction sintering step involves causing the metal silicon or the silicon alloy impregnated into the sintered compact to react with carbon in the sintered compact to form silicon carbide and thus to sinter the sintered compact.

In other words, in the Si infiltration step and the SiC reaction sintering step (Step S5), the sintered compact or the processed substrate is infiltrated with metal silicon or the silicon alloy at a high temperature higher than or equal to the melting point of metal silicon or the silicon alloy in a high-temperature vacuum or inert atmosphere. The metal silicon or the silicon alloy is then caused to react with carbon and a graphite powder in the sintered compact or the substrate to form silicon carbide.

To combine the matrix 11 with the reinforcing fiber 1, sintering includes causing metal silicon or the silicon alloy to react with carbon and the graphite powder in the sintered compact or the substrate to form silicon carbide while fixing boron carbide and the reinforcing fiber 1 to each other at the same time. In the sintering of the sintered compact or the processed substrate, carbon or graphite in the sintered compact or the substrate reacts with infiltrated silicon, and volume expansion occurs when carbon and graphite are converted into silicon carbide. This can prevent shrinkage of the sintered compact or the substrate during sintering.

The finishing step (Step S6), which is the final sixth step, involves finishing the sintered substrate or the sintered compact into an article shape after the Si infiltration step and the SiC reaction sintering step (Step S5). The sintered compact is finished into a final shape to provide an article composed of the ceramic matrix composite 10. Since the sintered compact before final finishing has a shape close to the shape of a final article, the sintered compact can be finished with a small amount of processing, which significantly improves productivity.

Next, whether it is necessary to combine the matrix 11 with the reinforcing fiber 1 in the ceramic matrix composite 10 will be described. The method for producing the ceramic matrix composite 10 when it is necessary to combine the matrix 11 with the reinforcing fiber 1 will also be described.

Whether the matrix 11 in the ceramic matrix composite 10 is combined with the reinforcing fiber 1 is determined according to the article shape and the properties of the final composite. For example, when the fracture toughness of the ceramic matrix composite 10 is not important, and the final article of the ceramic matrix composite 10 has a very complex shape with many thin portions, the ceramic matrix composite 10 does not necessarily have the reinforcing fiber 1 combined with the matrix 11, as shown in FIG. 1.

Examples of the case where the matrix 11 needs to be combined with the reinforcing fiber 1 include a case where it is necessary to reduce brittleness that is a characteristic of the fracture toughness of ceramic materials, and a case where articles have complex shapes and require uniformity in material physical properties. In these cases, for example, short fibers, such as cut fibers, are preferably used as the reinforcing fiber 1. The method for producing the ceramic matrix composite 10 in these cases includes, for example, mixing and combining the reinforcing fiber 1 with the raw material mixture in the raw material mixing step (Step S1) for mixing the raw materials as illustrated in FIG. 3. The step of combining the reinforcing fiber 1 with the matrix 11 or the raw materials of the matrix 11 is not limited to the step described above.

There are some cases where higher elastic modulus and higher strength are required in a particular direction from the viewpoint of the shape of an article formed by using the ceramic matrix composite 10 and the environment in which the article is used. For example, turbine blades of jet engines experience a large centrifugal load during rotation, and it is thus necessary to continuously align many reinforcing fibers 1 in the radial direction of turbines. To reduce damage, such as breakage of turbine blades, from impact, it is necessary to focus on the reinforcement of the surface using the reinforcing fibers 1. In this case, the reinforcing fibers 1 are added in the molding step (Step S2) as illustrated in FIG. 3. In the molding step (Step S2), the reinforcing fibers 1 are shaped in advance on the surface of the mold before the raw material mixture is charged into the mold, and the raw material mixture is then charged into the mold and molded, so that the reinforcing fibers 1 are preferentially disposed in a surface portion of the green compact and thus locally distributed in the surface portion of the green compact.

If an article to be formed by using the ceramic matrix composite 10 cannot be shaped only in the molding step (Step S2) due to its complex shape, the reinforcing fibers 1 may be shaped on the surface of the green compact after the green compact is shaped. The method for shaping the reinforcing fibers 1 in advance on the surface of the mold may be combined with the method for shaping the reinforcing fibers 1 on the surface of the green compact. When only the surface area of the ceramic matrix composite 10 needs to be reinforced with the reinforcing fibers 1, the reinforcing fibers 1 may be shaped on the surface of a green compact made of the raw material mixture by using a binder serving as a carbon precursor. A prepreg in which the reinforcing fibers 1 are combined with a binder in advance may be shaped.

To form an article having a relatively simple shape, such as a rod or a shaft, and particularly having strength and stiffness in the axial direction of the article, many reinforcing fibers 1 may be disposed in a central part of the mold to form a composite in the molding step (Step S2). In this case, the outer shape may be further shaped after molding, and the reinforcing fibers 1 may be added to the surface of the green compact after the outer shape is shaped.

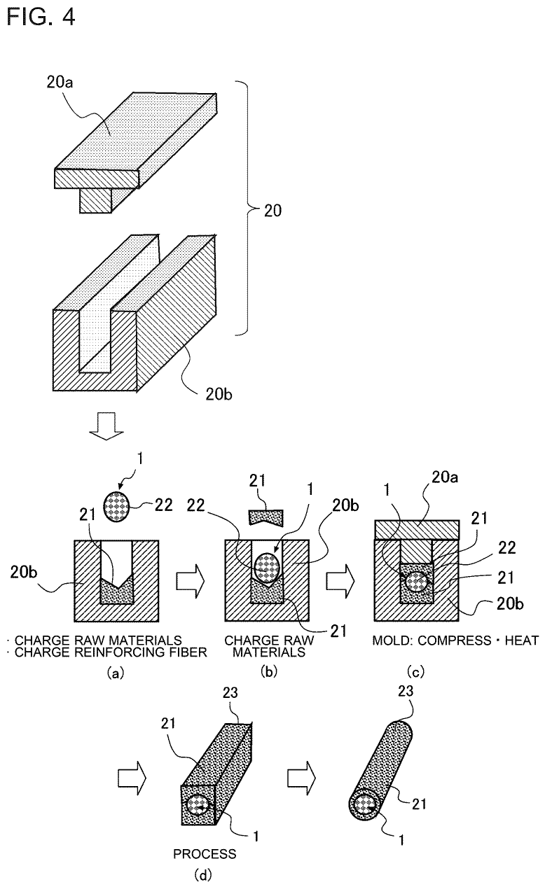

The form of incorporation of the reinforcing fibers 1 into the ceramic matrix composite 10 is optimized according to the shape of articles formed by using the ceramic matrix composite 10. The reinforcing fibers 1 may be incorporated in any step, or two or more steps from the raw material mixing step (Step S1) to the shaping step (Step S4) before the Si infiltration step and the SiC reaction sintering step (Step S5). For example, the reinforcing fibers 1 may be incorporated in the shaping step (Step S4) as illustrated in FIG. 4.

If an article formed by using the ceramic matrix composite 10 does not need to have heat resistance in an environment where the article is used, the surface of the sintered compact may be reinforced with the reinforcing fibers 1 after the Si infiltration step and the SiC reaction sintering step (Step S5).

The reinforcing fibers 1 may be unevenly distributed in the surface of the matrix 11, evenly distributed inside the matrix 11, or distributed in layers inside the matrix 11. In the molding step (Step S2), the reinforcing fibers 1 in the form of short fibers may be mixed with raw material powders and then charged, followed by molding. In this case, the alignment of the fibers or the amount of the charged fibers are adjusted according to the shape to be formed or the required strength properties.

### Examples

The details of the method for producing the ceramic matrix composite 10 according to one embodiment of the present disclosure will be described below by way of Examples, but the content of the present disclosure is not limited by these Examples. The raw materials used in Examples were Boron Carbide Powder F500 available from 3M for boron carbide and PG-9400 available from Gunei Chemical Industry Co., Ltd for a carbon precursor. The raw materials used in Examples were also K6371M available from Mitsubishi Chemical Corporation for graphite and GMF 1000H2 available from Pacific Rundum Co., Ltd for silicon carbide used as a matrix filler.

In the raw material mixing step (Step S1), boron carbide, the carbon precursor, graphite, and silicon carbide were mixed as raw materials at a weight ratio of 40:12:4:3 to form a raw material mixture.

In the case of using a milled fiber composed of a carbon fiber, the milled fiber composed of the carbon fiber does not change in volume or weight in the heat treatment in the downstream process, and the milled fiber is converted into silicon carbide (SiC) during subsequent SiC infiltration and SiC reaction sintering. At this time, the weight changes by a factor of 3.3, and the volume changes by a factor of 2.3. To obtain 50% or more of boron carbide (B₄C) by volume ratio, when the weight ratio of the milled fiber is 10% or less, and the weight ratio of boron carbide (B₄C) is 65% or more, the weight ratio of the resin and silicon carbide (SiC) is the remaining 25% such that the resin occupies a larger proportion than silicon carbide (SiC) (resin>silicon carbide (SiC)). This is an example. The weight ratios of the raw materials when the volume ratio of boron carbide (B₄C) in the matrix 11 after sintering is 50% or more may be such that the ratio between the resin and silicon carbide may be reversed when the ratio of the milled fiber decreases.

In the molding step (Step S2), the raw material mixture was charged into a mold, and the molding material in the mold was then pressed at a pressure of 5 MPa and cured with heat at a temperature of 150 degrees C. over 2 hours to form a green compact. Since generation of decomposition gas and shrinkage of the carbon precursor occur during thermal decomposition of the carbon precursor in the next heat treatment step (Step S3), the absence of voids in the green compact easily causes cracking in the green compact. The molding step (Step S2) does not require pressing the molding material into a dense green compact until the green compact becomes dense and has no void, and instead requires pressing the molding material such that voids remain in the green compact.

In the heat treatment step (Step S3), the green compact was heated to 800 degrees C. at a heating rate of 2 degrees C. per minute in an inert atmosphere. This state was further maintained for 2 hours, followed by slowly cooling to obtain a sintered compact. A small dimensional change was observed in the sintered compact, but there were no cracks or other problems.

In the Si infiltration step and the SiC reaction sintering step (Step S5), the sintered compact was placed together with metal silicon in a BN (boron nitride)-coated graphite crucible and heated to 1600 degrees C. under vacuum in a high-temperature vacuum furnace. This state was maintained for 1 hour, followed by slowly cooling to obtain a sintered compact.

The infiltration material used in Si infiltration and SiC reaction sintering may be a Si alloy containing silicon (Si) as a main component, in addition to metal silicon. The infiltration temperature needs to be higher than or equal to the melting point of the infiltration material. For metal silicon, the infiltration temperature needs to be higher than or equal to 1420 degrees C., which is the melting point of metal silicon, but the infiltration temperature is preferably a higher temperature in order that metal silicon reacts with carbon present inside the sintered compact to produce silicon carbide (SiC).

In Examples, the treatment was carried out under the conditions of 1-hour holding at 1600 degrees C., but the treatment temperature and the treatment time were preferably changed according to the shape or size of articles or other properties. The conditions are not limited to the treatment temperature at a melting temperature of 1600 degrees C. and the treatment time of 1-hour holding. When the sintered compact incorporates the reinforcing fiber 1, the melting temperature is preferably lower than 1800 degrees C. because the fiber deteriorates more at an excessively high temperature. To reduce the reaction deterioration of the fiber, the reinforcing fiber 1 having a fiber surface coated with carbon, boron carbide, or other substances in advance may be used in the incorporation of the reinforcing fiber 1.

The physical properties of the sintered compact, which was the ceramic matrix composite 10 obtained in the Si infiltration step and the SiC reaction sintering step (Step S5), were found to be a density of 2.68 (g/cm³), a Young's modulus of 430 GPa, and a specific elastic modulus of 160.4 (GPa/(g/cm³)). It is noted that the sintered compact found to have these physical properties does not incorporate the reinforcing fiber 1.

In this production process, the ceramic matrix composite 10 having a low specific gravity and a high elastic modulus can be produced under no pressure at a treatment temperature of about 1600 degrees C. for a short treatment time in the Si infiltration step and the SiC reaction sintering step (Step S5). Thus, articles having complex shapes or uneven thickness that are difficult to produce in a sintering process known in the related art can be produced for a short time, and the time for the finishing step (Step S6) required for articles having complex shapes or uneven thickness can be significantly shortened.

The ceramic matrix composite 10 containing boron carbide (B₄C) as a main component of the matrix 11 can be produced in the production process from the raw material mixing step (Step S1) to the Si infiltration step and the SiC reaction sintering step (Step S5) according to one embodiment of the present disclosure. Accordingly, a ceramic matrix composite having a higher specific elastic modulus than ceramic matrix composites known in the related art can be produced in the method for producing the ceramic matrix composite 10.

The method for producing the ceramic matrix composite 10 according to one embodiment of the present disclosure includes steps from the raw material mixing step (Step S1) to the Si infiltration step and the SiC reaction sintering step (Step S5). This production process enables the ceramic matrix composite 10 having a low density and a high elastic modulus to be produced at a temperature lower than that in a sintering process known in the related art and under no pressure. This makes it easy to produce articles having complex shapes and uneven thickness.

In addition, a combination of the matrix 11 with the reinforcing fiber 1 allows the ceramic matrix composite 10 to have a low density and a high elastic modulus. Since the brittleness of ceramic materials can be overcome by the combination with the reinforcing fiber 1, articles composed of the ceramic matrix composite 10 applicable to various structural parts can be produced.

The use of the boron carbide 2 (B₄C), a main component of the matrix 11, will be described. Boron carbide (B₄C) having a lower density and a higher elastic modulus than silicon carbide (SiC) has a Young's modulus of 450 GPa and a density of 2.52 (g/cm³) and therefore has a specific elastic modulus (450/2.52) of 178.6 (GPa/(g/cm³)). Boron carbide (B₄C) is a material expected to have a higher specific elastic modulus than silicon carbide (SiC).

However, sintering boron carbide (B₄C) requires a high pressure and a high temperature of 2000 degrees C. or higher and thus needs special facilities for production.

Boron carbide (B₄C) undergoes large shrinkage during sintering, and articles containing boron carbide (B₄C) easily break or crack, which makes it difficult to form and sinter articles having complex shapes, uneven thickness, or other shapes. It is thus difficult to produce articles containing boron carbide (B₄C) other than articles having a simple shape. To produce articles having complex shapes, it is necessary to cut sintered bulk materials and form shapes in a downstream process. However, boron carbide (B₄C) is very hard and poor in processability and makes it difficult to process parts having complex shapes.

When a matrix containing boron carbide (B₄C) is combined with a reinforcing fiber filler, such as a continuous fiber, to produce CMGs, the sintering process needs to be carried out at high temperature and high pressure, which makes it difficult to produce CMGs. Sintering boron carbide (B₄C) normally requires a temperature of 2000 degrees C. or higher as described above, and there is a limit to fibers that can be used among fibers that can be combined with a matrix due to restrictions on heat-resistant temperature. In the related art, the production of a CMC by combining a matrix containing boron carbide (B₄C) with a reinforcing fiber requires molding at high pressure during molding before sintering, which makes it difficult to combine the matrix with the reinforcing fiber and makes it difficult to combine the matrix with the reinforcing fiber in articles having complex shapes.

To produce the ceramic matrix composite 10 having a low density and a high elastic modulus, the method according to one embodiment of the present disclosure enables sintering of boron carbide (B₄C) at a temperature lower than 1800 degrees C., which is a temperature lower than that in a sintering process known in the related art, under no pressure in vacuum or in an inert atmosphere.

In the method according to one embodiment of the present disclosure, the composition of the matrix 11 is changed from a single component to multiple components to form a composite, boron carbide (B₄C) is used as a main component of the matrix 11, and the reaction production process of silicon carbide (SiC) in the Si infiltration step and the SiC reaction sintering step (Step S5) or other steps is introduced. The method according to one embodiment of the present disclosure can produce a sintered compact under no pressure. The method according to one embodiment of the present disclosure involves filling in gaps between raw materials and sintering the raw materials in the Si infiltration step and the SiC reaction sintering step (Step S5). This method thus prevents shrinkage of the sintered compact during sintering and enables production of a dense sintered compact under no pressure.

In the method according to one embodiment of the present disclosure, the composition of the matrix 11 is changed from a single component to multiple components to form a composite, boron carbide (B₄C) is used as a main component of the matrix 11, and the reaction production process of silicon carbide (SiC) in the Si infiltration step and the SiC reaction sintering step (Step S5) or other steps is introduced. The method according to one embodiment of the present disclosure can produce a dense sintered compact with very little sintering deformation. The reduction in sintering deformation of the sintered compact enables easy production of articles having uneven thickness, articles having complex shapes, or articles having large shapes.

In the method according to one embodiment of the present disclosure, the sintering temperature may be higher than or equal to 1420 degrees C., which is slightly higher than the melting point of silicon (Si), in the sintering process for the reaction production of silicon carbide (SiC) in the Si infiltration step and the SiC reaction sintering step (Step S5) or other steps. In the method according to one embodiment of the present disclosure, the reinforcing fiber 1 can be combined with boron carbide (B₄C). The method according to one embodiment of the present disclosure can produce the ceramic matrix composite 10 (CMC) having a high specific elastic modulus and allows the ceramic matrix composite 10 to have a higher heat-resistant temperature, a higher elastic modulus, and a lower density than CMGs known in the related art.

In the method according to one embodiment of the present disclosure, the matrix 11 can be combined with a carbon fiber having a higher elasticity than a SiC fiber, or a boron fiber, or other fibers in the sintering process for the reaction production of silicon carbide (SiC) in the Si infiltration step and the SiC reaction sintering step (Step S5) or other steps. The method according to one embodiment of the present disclosure can thus produce the ceramic matrix composite 10 having a lower density and a higher elastic modulus than SiC/SiC known in the related art.

In the method according to one embodiment of the present disclosure, a raw material mixture including a boron carbide (B₄C) powder, a matrix filler, such as a silicon carbide (SiC) powder and a graphite powder, and a carbon precursor is molded into a green compact in the molding step (Step S2), and the green compact is subjected to a heat treatment in the heat treatment step (Step S3). In the molding step (Step S2) and the heat treatment step (Step S3), the reinforcing fiber 1 may be contained. In the method according to one embodiment of the present disclosure, the carbonization of the carbon precursor in the heat treatment after the molding step can produce a porous sintered compact that can be infiltrated with silicon (Si), that is, a porous sintered compact. The sintered compact is soft due to its porosity and high in processability and has strength enough for shaping. In addition, the sintered compact undergoes less dimensional change during sintering and thus enables easy formation of articles having complex shapes.

The ceramic matrix composite 10 contains metal silicon or an alloy of metal silicon. A combination of boron carbide (B₄C), silicon carbide (SiC), and metal silicon or an alloy of metal silicon can reduce the density of the ceramic matrix composite 10 and can increase the specific elastic modulus of the ceramic matrix composite 10 to increase the specific elastic modulus.

The production process for further charging the reinforcing fiber 1 in the molding step (Step S2) allows the ceramic matrix composite having a low density and a high elastic modulus to be produced at a temperature lower than that in a sintering process known in the related art and under no pressure. This makes it easy to produce articles having complex shapes with uneven thickness.

As described in Embodiment 1, the use of a resin as the carbon precursor enables easy formation of the green compact. In addition, the use of a resin as the carbon precursor causes thermal decomposition of the carbon precursor in the heat treatment step (Step S4) to induce volume shrinkage. This ensures, in the sintered compact, voids required for the next step, that is, the Si infiltration step and the SiC reaction sintering step (Step S5).

A combination of the resin with one or both of a graphite powder and a carbon fiber in the carbon precursor can improve the moldability of the green compact and can also prevent or reduce strain generated during the heat treatment. This can prevent breakage of the green compact during sintering and can prevent cracking. A combination of the resin with one or both of a graphite powder and a carbon fiber in the carbon precursor can ensure the void volume required for the Si infiltration step and the SiC reaction sintering step (Step S5) and can adjust the space that expands in the reaction for producing silicon carbide. The ceramic matrix composite 10 may have a complex shape or an uneven thickness because dimensional change can be reduced during the production process.

In the ceramic matrix composite 10, the matrix filler is partially composed of a silicon carbide powder. This configuration can ensure the void volume required for the Si infiltration step and the SiC reaction sintering step (Step S5) and can adjust the space that expands in the reaction for producing silicon carbide. The ceramic matrix composite 10 may have a complex shape or an uneven thickness because dimensional change can be reduced during the production process.

The average particle size distribution of the powder raw materials in the raw material mixture preferably has two or more different modes. When the average particle size distribution of the powder raw materials has two or more different modes, the packing rate of the raw material mixture can be improved and furthermore, the raw material mixture can be homogenized. The ceramic matrix composite 10 can be more homogenized than a ceramic matrix composite not having such a configuration, which can improve the properties of the ceramic matrix composite.

### Embodiment 3

FIG. 4 is a flowchart of a molding process for incorporating the reinforcing fiber 1 as the core of a rod into the ceramic matrix composite 10 according to Embodiment 3. The same components as those in the ceramic matrix composite 10 according to Embodiment 1 and Embodiment 2 are assigned with the same reference signs, and description thereof is omitted. An example method for incorporating the reinforcing fiber 1 will be described with reference to FIG. 4, focusing on the molding step (Step S2).

### Examples

The raw materials used in Examples were Boron Carbide Powder F500 available from 3M for boron carbide and PG-9400 available from Gunei Chemical Industry Co., Ltd for a carbon precursor. The raw materials used in Examples were also K6371 M available from Mitsubishi Chemical Corporation for graphite and GMF 1000H2 available from Pacific Rundum Co., Ltd for silicon carbide used as a matrix filler.

A raw material mixture 21 prepared in the same manner as in Embodiment 2 in the raw material mixing step (Step S1) illustrated in FIG. 3 and a prepreg sheet 22 used as the reinforcing fiber 1 are prepared. The prepreg sheet 22 was HyE J34M64PD, which is a UD prepreg sheet available from Mitsubishi Chemical Corporation. A molding jig 20 used as a mold has a mold 20a having a T-shape and a mold 20b having a U-shape. In the molding step (Step S2), the molding material disposed inside the mold 20b is pressed by the mold 20a to form a green compact having a square rod shape.

As shown in step (a) and step (b) in FIG. 4, the raw material mixture 21, the prepreg sheet 22, and the raw material mixture 21 were placed in this order from below in the molding jig 20 prepared for molding. At this time, the prepreg sheet 22 was set in a rod shape rolled in advance such that fibers were aligned in the longitudinal direction of the molding jig 20. The rod shape is, for example, a cylindrical shape. In the prepreg sheet 22 having a rod shape, which is the reinforcing fiber 1 to be set, the preformed resin has been cured. The raw material mixture 21 is charged to cover the outer surface of the prepreg sheet 22 having a rod shape. The raw material mixture 21, the prepreg sheet 22, and the raw material mixture 21 were charged as materials into the molding jig 20 such that the weight ratio of the materials was 2:1:2.

In the molding illustrated in step (c) in FIG. 4, the molding material in the molding jig 20 was pressed at a pressure of 3 MPa and cured with heat at a temperature of 150 degrees C. over 2 hours to form a green compact 23. Since the green compact 23 had a square rod shape in which the reinforcing fiber 1 was concentrated around the center and the raw material mixture 21 was cured around the outer surface of the reinforcing fiber 1, a cured portion of excess raw material mixture 21 was cut off to form a round rod shape in the downstream process (d). The area ratio of the reinforcing fiber 1 in the central part to a raw material mixture 21 part outside the reinforcing fiber 1 was about 1:1 in the cross-section of the green compact 23 processed to have a round rod shape.

The prepreg sheet 22 is of UD (Uni-Directional) type having only unidirectional fibers but is not limited to the UD type. The prepreg sheet 22 may have a braid texture in which fibers are woven or may be a tubular braid. The sheet set in the molding jig may be a bundle of fibers before prepregging instead of a prepreg having a combination of fibers and a resin.

A carbon fiber was used as the reinforcing fiber 1, but the reinforcing fiber 1 may be, in addition to a carbon fiber, a SiC fiber, an alumina fiber, a boron fiber, a basalt fiber, or other fibers. To further improve the specific elastic modulus of the ceramic matrix composite 10, a combination of super elastic carbon fibers having a high elastic modulus is the most preferred. The reinforcing fiber 1 is disposed in a central part of the green compact 23, but the reinforcing fiber 1 is not necessarily disposed in a central part of the green compact 23. For example, the reinforcing fiber 1 may be concentrated and dispersed in the surface of the green compact 23, or may be uniformly dispersed in the entire green compact 23, or may be concentrated in the surface and the central part of the green compact 23. The ratio between the reinforcing fiber 1 and the raw material mixture 21 charged can be freely selected.

The green compact 23 processed under the conditions of a temperature of 800 degrees C. in an inert atmosphere for 2 hours was then subjected to a heat treatment in the heat treatment step (Step S3) to carbonize the carbon precursor in the raw material mixture 21 and the resin of the prepreg sheet 22 and thus to obtain a sintered compact.

In the Si infiltration step and the SiC reaction sintering step (Step S5), the sintered compact was then heated to 1600 degrees C. together with metal silicon under vacuum. That state was maintained for 1 hour, and the sintered compact was infiltrated with silicon, whereby the sintered compact was sintered to form a sintered compact.

The sintered compact thus obtained was finished into a round bar having a uniform diameter by grinding the surface of the rod of the sintered compact, and the density and the elastic modulus were evaluated. The density was 2.35 (g/cm³), the elastic modulus was 490 GPa, and the specific elastic modulus was 208.5 (GPa/(g/cm³)).

The reinforcing fiber 1 incorporated as the core of the rod part into the ceramic matrix composite 10 realizes lower density and higher elastic modulus, which is difficult to achieve with ceramic materials alone, than those of common ceramic materials. The application of the ceramic matrix composite 10, which is produced in the production process, to various articles leads to weight reduction due to low density and realizes high-speed driving or driving energy saving. The application of the ceramic matrix composite 10 to various articles also leads to high stiffness due to high elastic modulus and reduces strain under load to realize high precision or higher-speed driving.

The configurations in Embodiment 1 to Embodiment 3 described above illustrate examples of the contents of the present disclosure and can be combined with other known techniques or can be partially omitted or changed without departing from the gist of the present disclosure.

### REFERENCE SIGNS LIST

1: reinforcing fiber, 2: boron carbide, 3: silicon carbide, 4: silicon, 10: ceramic matrix composite, 11: matrix, 20: molding jig, 20a: mold, 20b: mold, 21: raw material mixture, 22: prepreg sheet, 23: green compact

1.-3. (canceled)

4. A method for producing a ceramic matrix composite, the method comprising:
mixing a boron carbide powder, a carbon precursor containing powdery phenol resin, and a matrix filler to form a raw material mixture;
performing molding by charging the raw material mixture and reinforcing fiber into a mold and heating and pressing the raw material mixture into a green compact;
performing a heat treatment by heating the green compact in an inert atmosphere or in vacuum to carbonize the carbon precursor and thus to obtain a sintered compact;
performing infiltration by heating the sintered compact in an inert atmosphere or in vacuum and melting metal silicon or a silicon alloy to impregnate the sintered compact with metal silicon or the silicon alloy; and
performing reaction sintering by causing the metal silicon or the silicon alloy impregnated into the sintered compact to react with carbon in the sintered compact to form silicon carbide and thus to sinter the sintered compact,
wherein a part of the matrix filler is a silicon carbide powder.

5. The method for producing a ceramic matrix composite of claim 4, further comprising, between the heat treatment and the infiltration, processing the sintered compact into a part shape to form a substrate,
wherein, when the method comprises the processing, the sintered compact in the infiltration and the reaction sintering is the substrate.

6. (canceled)

7. The method for producing a ceramic matrix composite of claim 4, wherein the reinforcing fiber is any one of carbon fibers, boron fibers, and inorganic fibers, or a combination of two or more of carbon fibers, boron fibers, and inorganic fibers.

8.-9. (canceled)

10. The method for producing a ceramic matrix composite of claim 4, wherein an average particle size distribution of powder raw materials in the raw material mixture has two or more different modes.
